(19) United States
(12) Patent Application Publication
(10) Pub. No.: US 2022/0025204 A1
(43) Pub. Date: Jan. 27, 2022

(54) Dispersion, Ink Composition For Ink Jet Recording, And Dispersing Resin

(71) Applicant: Seiko Epson Corporation, Tokyo (JP)

(72) Inventors: Toshihiro OTAKE, Chino (JP); Koichi TERAO, Suwa (JP); Mami TOJINO, Shiojiri (JP); Hiroshi ITO, Matsumoto (JP); Koji HORIBA, Matsumoto (JP)

(21) Appl. No.: 17/380,071

(22) Filed: Jul. 20, 2021

(30) Foreign Application Priority Data
Jul. 21, 2020 (JP) 2020-124148

(51) Int. Cl. C09D 17/00; C08F 220/18; C08F 220/06; C08F 212/08; C08F 220/58; C09D 11/326; C09D 11/328; C09D 11/38; C09D 11/033

(52) U.S. Cl. CPC C09D 17/001; C08F 220/1804; C08F 220/06; C08F 212/08; C09D 11/033; C09D 11/326; C09D 11/328; C09D 11/38; C08F 220/585

(57) ABSTRACT

A dispersion contains water, a color material, and a dispersing resin that disperses the color material, the dispersing resin having a structural unit A containing a hydrophobic monomer, a structural unit B containing a hydrophilic acrylic acid monomer, and a structural unit C containing a sulfonic acid group-containing acrylamide monomer, where the dispersing resin has a weight average molecular weight of from 5000 to 100000 and a content of the structural unit A is 60 mol % or more with respect to a total amount of the dispersing resin.

The present application is based on, and claims priority from JP Application Serial Number 2020-124148, filed Jul. 21, 2020, the disclosure of which is hereby incorporated by reference herein in its entirety.

### BACKGROUND

### 1. Technical Field

The present disclosure relates to a dispersion, an ink composition for ink jet recording, and a dispersing resin.

### 2. Related Art

Ink jet recording methods enable the recording of high-definition images with a relatively simple apparatus and have achieved rapid advancement in various fields. Among them, various studies have been conducted on obtaining high-resolution images at the same time as preventing or reducing the mist contamination of a recording head. For example, JP-A-2017-002096 discloses a pigment ink for ink jet recording in which pigment particles are dispersed with a styrene-acrylic resin.

However, the ink composition containing an existing dispersant, such as a styrene-acrylic resin, disclosed in JP-A-2017-002096 has a problem where once ink is dried to solidify a color material, the redispersion thereafter is unlikely to occur, resulting in the likely occurrence of defects during ejection.

### SUMMARY

The present disclosure is a dispersion containing water, a color material, and a dispersing resin that disperses the color material, the dispersing resin having a structural unit A containing a hydrophobic monomer, a structural unit B containing a hydrophilic acrylic acid monomer, and a structural unit C containing a sulfonic acid group-containing acrylamide monomer, where the dispersing resin has a weight average molecular weight of from 5000 to 100000 and a content of the structural unit A is 60 mol % or more with respect to a total amount of the dispersing resin.

Furthermore, the present disclosure is an ink composition for ink jet recording containing the above-described dispersion, a surfactant, and a water-soluble organic solvent.

Furthermore, the present disclosure is a dispersing resin having a structural unit A containing a hydrophobic monomer, a structural unit B containing a hydrophilic acrylic acid monomer, and a structural unit C containing a sulfonic acid group-containing acrylamide monomer, where the dispersing resin has a weight average molecular weight of from 5000 to 100000 and a content of the structural unit A is 60 mol % or more with respect to a total amount of the dispersing resin.

### DESCRIPTION OF EXEMPLARY EMBODIMENTS

Although an embodiment of the present disclosure (hereinafter referred to as the “present embodiment”) will be hereinafter described in detail, the present disclosure is not limited thereto, and various modifications can be made within the scope that does not depart from the spirit the present disclosure.

### 1. Dispersion

A dispersion according to the present embodiment contains water, a color material, and a dispersing resin that disperses the color material, the dispersing resin having a structural unit A containing a hydrophobic monomer, a structural unit B containing a hydrophilic acrylic acid monomer, and a structural unit C containing a sulfonic acid group-containing acrylamide monomer, where the dispersing resin has a weight average molecular weight of from 5000 to 100000 and a content of the structural unit A is 60 mol % or more with respect to a total amount of the dispersing resin.

A dispersion or an ink composition using an existing dispersing resin has a problem where once a color material is solidified, its redispersion is unlikely to occur. In contrast, in the present embodiment, by using a dispersing resin having the above-described structure, the easy redispersion of such a solidified color material is enabled, and even when stored at a high temperature, the particle diameter change of the color material particles and the viscosity change of a dispersion are small, thereby enabling an ink composition for ink jet recording using the dispersion to achieve further enhanced prevention of clogging and to have further enhanced ejection stability. Hereinafter, each component will be described in detail.

### 1.1. Dispersing Resin

A dispersing resin according to the present embodiment is a copolymer having a structural unit A containing a hydrophobic monomer, a structural unit B containing a hydrophilic acrylic acid monomer, and a structural unit C containing a sulfonic acid group-containing acrylamide monomer. In the present embodiment, the term “monomer” refers to a monomer before polymerization, the monomer having a polymerizable unsaturated bond, and the term “structural unit” refers to a repeat unit forming a portion of the dispersing resin after polymerization. In the present embodiment, the term “hydrophobicity” refers to a property of being incompatible with water at 25° C. and the term “hydrophilicity” refers to a property of being compatible with water at 25° C.

The dispersing resin may be a random copolymer or a block copolymer. Examples of the block copolymer include, in addition to a triblock copolymer having a block A formed of the structural unit A, a block B formed of the structural unit B, and a block C formed of the structural unit C, a diblock copolymer having a block A formed of the structural unit A and a random block B/C formed of the structural unit B and the structural unit C. By using such a dispersing resin, the redispersibility after solidification is further enhanced, and even when stored at a high temperature, the particle diameter change and the viscosity change tend to be smaller.

The content of the dispersing resin is preferably from 2.5 to 10% by mass, more preferably from 3.5 to 9.0% by mass, and even more preferably from 4.5 to 8.0% by mass with respect to the total amount of the dispersion. When the content of the dispersing resin is within the foregoing range, the redispersibility after solidification is further enhanced, and even when stored at a high temperature, the particle diameter change and the viscosity change tend to be smaller.

The content of the dispersing resin is preferably from 10 to 80 parts by mass, more preferably from 15 to 70 parts by mass, and even more preferably from 25 to 60 parts by mass with respect to 100 parts by mass of the color material. When the content of the dispersing resin is within the foregoing range, the redispersibility after solidification is further enhanced, and even when stored at a high temperature, the particle diameter change and the viscosity change tend to be smaller.

### 1.1.1. Structural Unit A

The structural unit A is a structural unit containing a hydrophobic monomer and partially imparts hydrophobicity to the dispersing resin. The structural unit A is not particularly limited, but is oriented to a surface of the color material due to, for example, a hydrophobic interaction, and can contribute to the adsorption of the dispersing resin to the color material.

The hydrophobic monomer forming the structural unit A is not particularly limited, but examples thereof include an aromatic group-containing vinyl monomer such as styrene, methylstyrene, and other styrene derivatives; and a hydrocarbon group-containing acrylic acid ester monomer such as methyl (meth)acrylate, ethyl (meth)acrylate, butyl (meth)acrylate, isopropyl (meth)acrylate, isobutyl (meth)acrylate, pentyl (meth)acrylate, isoamyl (meth)acrylate, hexyl (meth)acrylate, 2-ethylhexyl (meth)acrylate, and benzyl (meth)acrylate. Among these, styrene, methyl (meth)acrylate, ethyl (meth)acrylate, and butyl (meth)acrylate are more preferable. By using such a hydrophobic monomer, the absorptivity of the dispersing resin to the color material is further enhanced, the redispersibility after solidification is further enhanced, and even when stored at a high temperature, the particle diameter change and the viscosity change tend to be smaller. The hydrophobic monomer may be used alone or in a combination of two or more kinds. In the present embodiment, the term “(meth)acrylate” encompasses acrylate and methacrylate.

The content of the structural unit A is 60 mol % or more, preferably from 61 to 80 mol %, and more preferably from 61 to 70 mol % with respect to the total amount of the dispersing resin. When the content of the structural unit A is 60 mol % or more, the absorptivity of the dispersing resin to the color material is further enhanced. Furthermore, normally, when the content of the hydrophobic structural unit A is as much as 60 mol % or more, the hydrophilicity of a dispersing resin per se is deteriorated, but the dispersing resin according to the present embodiment is enabled to obtain the water-solubility of the dispersing resin due to the contribution of the other structural units, particularly that of the structural unit C. Thus, the absorptivity of the dispersing resin to the color material is further enhanced, the redispersibility after solidification is further enhanced, and even when stored at a high temperature, the particle diameter change and the viscosity change tend to be smaller.

### 1.1.2. Structural Unit B

The structural unit B is a structural unit containing a hydrophilic acrylic acid monomer and partially imparts hydrophilicity to the dispersing resin. The structural unit B is not particularly limited, but is oriented to a side opposite to the surface of the color material and can contribute to the enhancement of dispersibility.

The hydrophilic acrylic acid monomer forming the structural unit B is not particularly limited, but examples thereof include a (meth)acrylic acid; a polyalkylene glycol group-containing acrylic acid ester monomer such as ethylene glycol (meth)acrylate, diethylene glycol (meth)acrylate, polyethylene glycol (meth)acrylate, and methoxy polyethylene glycol (meth)acrylate; and other acrylic acid ester monomers such as 2-hydroxyethyl (meth)acrylate. Among these, a (meth)acrylic acid and a polyalkylene glycol group-containing acrylic acid ester monomer are preferable. The hydrophilic acrylic acid monomer may be used alone or in a combination of two or more kinds. In the present embodiment, the term “(meth)acrylic acid” encompasses acrylic acid and methacrylic acid.

The content of the structural unit B is preferably from 3 to 25 mol %, preferably from 5 to 20 mol %, and more preferably from 7 to 16 mol % with respect to the total amount of the dispersing resin. When the content of the structural unit B is within the foregoing range, the hydrophilicity of the dispersing resin is further enhanced, the redispersibility after solidification is further enhanced, and even when stored at a high temperature, the particle diameter change and the viscosity change tend to be smaller.

### 1.1.3. Structural Unit C

The structural unit C is a structural unit containing a sulfonic acid group-containing acrylamide monomer and partially imparts hydrophilicity to the dispersing resin. The structural unit C is not particularly limited, but is oriented to a side opposite to the surface of the color material and can contribute to the enhancement of dispersibility.

The sulfonic acid group-containing acrylamide monomer forming the structural unit C is not particularly limited, but examples thereof include compounds represented by a general formula (1) below. Among these, 2-acrylamido-2-methylpropanesulfonic acid is more preferable. By using such an acrylamide monomer, the hydrophilicity of the dispersing resin is further enhanced, the redispersibility after solidification is further enhanced, and even when stored at a high temperature, the particle diameter change and the viscosity change tend to be smaller. The acrylamide monomer may be used alone or in a combination of two or more kinds.

CH═CONH—R—SO₃H (1)

(wherein R represents a linear, branched, or cyclic alkyl group having from 1 to 6 carbon atoms.)

The sulfonic acid group of the acrylamide monomer may form a salt. The salt is not particularly limited, but examples thereof include alkali metal salts such as a salt derived from, for example, potassium; alkaline earth metal salts such as a salt derived from, for example, calcium or magnesium; ammonium salts; and alkylamine salts.

The content of the structural unit C is preferably from 10 to 40 mol %, more preferably from 10 to 35 mol %, and even more preferably from 15 to 32 mol % with respect to the total amount of the dispersing resin. When the content of the structural unit C is within the foregoing range, the hydrophilicity of the dispersing resin is further enhanced, the redispersibility after solidification is further enhanced, and even when stored at a high temperature, the particle diameter change and the viscosity change tend to be smaller. Particularly because the dispersing resin has the structural unit C, the redispersibility after solidification is further enhanced.

### 1.1.4. Weight Average Molecular Weight and Molecular Weight Distribution

The dispersing resin has a weight average molecular weight of from 5000 to 100000, preferably from 5000 to 80000, more preferably from 7000 to 60000, and even more preferably from 7000 to 30000. When the weight average molecular weight of the dispersing resin is within the foregoing range, the redispersibility after solidification is further enhanced, and even when stored at a high temperature, the particle diameter change and the viscosity change tend to be smaller.

The molecular weight distribution (Mw/Mn) of the dispersing resin is preferably from 1.05 to 2.00, more preferably from 1.05 to 1.80, even more preferably from 1.05 to 1.60, and particularly preferably from 1.05 to 1.40. When the molecular weight distribution of the dispersing resin is within the foregoing range, not only the size of the molecules becomes more uniform and the redispersibility after solidification is further enhanced, but also the particle diameter change and the viscosity change tend to be smaller. Such a relatively narrow molecular weight distribution can be achieved by, for example, living radical polymerization described below.

The weight average molecular weight and the molecular weight distribution can be measured in accordance with a publicly known method, for example, a chromatography method. More specifically, these can be measured in accordance with a method described in Example.

### 1.1.5. Production Method

The dispersing resin according to the present embodiment can be obtained by copolymerizing the above-described hydrophobic monomer and the above-described acrylamide monomer in order. The polymerization reaction is not particularly limited, but, for example, radical polymerization, particularly living radical polymerization, can be used.

### 1.2. Water

The content of water is preferably from 60 to 90% by mass, more preferably from 65 to 90% by mass, and even more preferably from 75 to 90% by mass with respect to the total amount of the dispersion.

### 1.3. Color Material

The color material is not particularly limited, but examples thereof include a disperse dye and a pigment. The color material may be used alone or in a combination of two or more kinds.

The disperse dye is not particularly limited, and publicly known disperse dyes such as C.I. Disperse Yellow, C.I. Disperse Orange, C.I. Disperse Blue, C.I. Disperse Violet, and C.I. Disperse Black can be used.

The inorganic pigment is not particularly limited, but examples thereof include carbon black (C.I. Pigment Black 7) such as furnace black, lamp black, acetylene black, and channel black, an iron oxide, and a titanium oxide.

The organic pigment is not particularly limited, but examples thereof include a quinacridone pigment, a quinacridone quinone pigment, a dioxazine pigment, a phthalocyanine pigment, an anthrapyrimidine pigment, an anthanthrone pigment, an indanthrone pigment, a flavanthrone pigment, a perylene pigment, a diketopyrrolopyrrole pigment, a perinone pigment, a quinophthalone pigment, an anthraquinone pigment, a thioindigo pigment, a benzimidazolone pigment, an isoindolinone pigment, an azomethine pigment, and an azo pigment.

The content of the color material is preferably from 7.5 to 30% by mass, more preferably from 8.0 to 20% by mass, and even more preferably from 8.5 to 15% by mass with respect to the total amount of the dispersion.

### 1.4. pH Adjuster

The dispersion may further contain a pH adjuster. The pH adjuster is not particularly limited, but examples thereof include an inorganic acid (e.g., sulfuric acid, hydrochloric acid, and nitric acid), an inorganic base (e.g., lithium hydroxide, sodium hydroxide, potassium hydroxide, and ammonia), an organic base (e.g., triethanolamine, diethanolamine, monoethanolamine, and tripropanolamine), and an organic acid (e.g., adipic acid, citric acid, and succinic acid). The pH adjuster may be used alone or in a mixture of two or more kinds.

### 2. Ink Composition for Ink Jet Recording

An ink composition for ink jet recording according to the present embodiment (also simply referred to as an “ink composition”) contains the above-described dispersion, a surfactant, and a water-soluble organic solvent, and, as needed, may contain other components. The term “for ink jet recording” refers to being used in accordance with an ink jet method in which ink droplets are ejected from a nozzle of an ink jet head.

### 2.1. Dispersion

The dispersion is as described above. The content of the above-described dispersing resin added to the ink composition together with the dispersion is preferably from 0.1 to 3.0% by mass, more preferably from 0.3 to 2.0% by mass, and even more preferably from 0.5 to 1.5% by mass with respect to the total amount of the ink composition. When the content of the dispersing resin is within the foregoing range, the redispersibility after solidification is further enhanced, and even when stored at a high temperature, the particle diameter change and the viscosity change tend to be smaller.

The content of the above-described color material added to the ink composition together with the dispersion is preferably from 1.0 to 7.0% by mass, more preferably from 1.5 to 6.0% by mass, and even more preferably from 2.5 to 4.5% by mass with respect to the total amount of the ink composition. When the content of the color material is within the foregoing range, the redispersibility after solidification is further enhanced, and even when stored at a high temperature, the particle diameter change and the viscosity change tend to be smaller.

In the ink composition, the content of the dispersing resin is preferably from 10 to 80 parts by mass, more preferably from 15 to 70 parts by mass, and even more preferably from 25 to 60 parts by mass with respect to 100 parts by mass of the color material. When the content of the dispersing resin is within the foregoing range, the redispersibility after solidification is further enhanced, and even when stored at a high temperature, the particle diameter change and the viscosity change tend to be smaller.

### 2.2. Surfactant

The surfactant is not particularly limited, but examples thereof include an acetylene glycol surfactant, a fluorosurfactant, and a silicone surfactant.

The acetylene glycol surfactant is not particularly limited, but is preferably one or more kinds selected from, for example, 2,4,7,9-tetramethyl-5-decyne-4,7-diol and an alkylene oxide adduct of 2,4,7,9-tetramethyl-5-decyne-4,7-diol; and a 2,4-dimethyl-5-decyne-4-ol and an alkylene oxide adduct of 2,4-dimethyl-5-decyne-4-ol.

The fluorosurfactant is not particularly limited, but examples thereof include a perfluoroalkyl sulfonic acid salt, a perfluoroalkyl carboxylic acid salt, a perfluoroalkyl phosphoric acid ester, a perfluoroalkyl ethylene oxide adduct, perfluoroalkyl betaine, and a perfluoroalkylamine oxide compound.

Examples of the silicone surfactant include a polysiloxane compound and a polyether-modified organosiloxane.

The content of the surfactant is preferably from 0.1 to 3.0% by mass and more preferably from 0.1 to 1.0% by mass with respect to the total amount of the ink composition.

### 2.3. Water-Soluble Organic Solvent

The water-soluble organic solvent is not particularly limited, but examples thereof include glycerol; glycols such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, and 1,6-hexanediol; glycol monoethers such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, and triethylene glycol monomethyl ether; nitrogen-containing solvents such as 2-pyrrolidone, N-methyl-2-pyrrolidone, and N-ethyl-2-pyrrolidone; and alcohols such as methanol, ethanol, n-propyl alcohol, iso-propyl alcohol, n-butanol, 2-butanol, tert-butanol, iso-butanol, n-pentanol, 2-pentanol, 3-pentanol, and tert-pentanol. Among these, glycols are preferable, and diethylene glycol and 1,2-hexanediol are more preferable. The water-soluble organic solvent may be used alone or in a combination of two or more kinds.

The content of the water-soluble organic solvent is preferably from 5.0 to 30% by mass and more preferably from 10 to 20% by mass with respect to the total amount of the ink composition. When the content of the water-soluble organic solvent is within the foregoing range, the redispersibility after solidification is further enhanced, and even when stored at a high temperature, the particle diameter change and the viscosity change tend to be smaller.

### 2.4. Water

The content of the water is preferably from 60 to 90% by mass and more preferably from 70 to 85% by mass with respect to the total amount of the ink composition. When the content of the water is within the foregoing range, the redispersibility after solidification is further enhanced, and even when stored at a high temperature, the particle diameter change and the viscosity change tend to be smaller.

### 2.5. pH Adjuster

The ink composition may further contain a pH adjuster. The pH adjuster is not particularly limited, but examples thereof include the pH adjusters exemplified in the description of the dispersion. The pH adjuster in the ink composition may be derived from the dispersion and mixed or may be added separately during the preparation of the ink composition.

The content of the pH adjuster is preferably from 0.1 to 2.0% by mass and more preferably from 0.5 to 1.5% by mass with respect to the total amount of the ink composition.

### 2.6. Other Resins

The ink composition may further contain other resins than the dispersing resin. Such other resins are not particularly limited, but examples thereof include an anionic resin, a cationic resin, and a nonionic resin. By containing such a resin, the color material can be caused to adhere to a recording medium.

The cationic resin is not particularly limited, but examples thereof include starch derivatives such as a cationic starch, a cationic urethane resin, a cationic olefin resin, and a cationic allylamine resin.

Examples of the anionic resin include cellulose derivatives such as a carboxymethyl cellulose salt and viscose and natural resins such as an alginic acid salt, gum arabic, gum tragacanth, and a lignin sulfonic acid salt.

The nonionic resin is not particularly limited, but examples thereof include an acrylic resin, a styrene-acrylic resin, a urethane resin, an ester resin, an olefin resin, and a vinyl acetate resin.

The content of such other resins is preferably from 0.1 to 2.0% by mass and more preferably from 0.5 to 1.5% by mass with respect to the total amount of the ink composition.

### EXAMPLES

Hereinafter, the present disclosure will be described more specifically using Examples and Comparative Example. The Examples below are not intended to limit the present disclosure in any way.

### 1. Synthesis of Copolymers

### 1.1. Production Example 1

Into a side-arm flask equipped with a stirring bar and a Dimroth condenser, 16 parts by mass of styrene, 16 parts by mass of 2-acrylamido-2-methylpropanesulfonic acid, 5 parts by mass of acrylic acid, 2 parts by mass of 2-{[(carboxymethyl)sulfanylthiocarbonyl]sulfanyl}propanoic acid (CSPA), and 1 part by mass of azobisisobutyronitrile were placed, and the mixture was dissolved with 60 parts by mass of N,N-dimethylformamide.

After nitrogen bubbling was performed on the solution in the flask for 20 minutes, the solution was heated to 75° C. in a nitrogen atmosphere to perform a polymerization reaction for 6 hours. After the reaction was finished, the reaction product was diluted with tetrahydrofuran and added dropwise to hexane to deposit a yellow solid. The deposited solid was collected through centrifugation and vacuum-dried at 50° C. for 10 hours to obtain a dispersing resin 1. The weight average molecular weight of the obtained dispersing resin was 8200. Any of the reagents used in the above description is manufactured by Tokyo Chemical Industry Co., Ltd.

### 1.2. Production Examples from 2 to 5

The same method as in Production Example 1 was used to synthesize dispersing resins from 2 to 5 except that the kind and the amount of the monomers used were changed such that the dispersing resins presented in Table 1 below would be obtained. The PME 400 used in Production Examples 3 and 4 is methoxy polyethylene glycol methacrylate (manufactured by NOF Corporation).

### 1.3. Weight Average Molecular Weight and Molecular Weight Distribution

In accordance with a chromatography method, the weight average molecular weight of each dispersing resin and each polymer A obtained as described above and the molecular weight distribution (Mw/Mn) of each dispersing resin were measured. The conditions are presented below.

### Measurement Conditions

Apparatus name: HLC8320GPC (Tosoh Corporation)
Guard column: Super AW-L

### Column: Super AW3000

Column temperature: 25° C.

### Eluate: Dimethylacetamide

Flow rate: 0.6 mL/min

### Detector: RI

TABLE 1

| | | STRUCTURAL | | STRUCTURAL | | STRUCTURAL | | | |
|---|---|---|---|---|---|---|---|---|---|
| | | UNIT A | | UNIT B | | UNIT C | | | |
| | | MONOMER | mol % | MONOMER | mol % | MONOMER | mol % | Mw | Mw/Mn |
| PRODUCTION | DISPERSING | STYRENE | 70 | ACRYLIC | 15 | ATBS | 15 | 8200 | 1.40 |
| EXAMPLE 1 | RESIN 1 | | | ACID | | | | | |
| PRODUCTION | DISPERSING | BUTYL | 68 | ACRYLIC | 16 | ATBS | 16 | 8000 | 1.40 |
| EXAMPLE 2 | RESIN 2 | ACRYLATE | | ACID | | | | | |
| PRODUCTION | DISPERSING | STYRENE | 61 | PME400 | 7 | ATBS | 32 | 7600 | 1.40 |
| EXAMPLE 3 | RESIN 3 | | | | | | | | |
| PRODUCTION | DISPERSING | BUTYL | 62 | PME400 | 8 | ATBS | 30 | 8000 | 1.40 |
| EXAMPLE 4 | RESIN 4 | ACRYLATE | | | | | | | |
| PRODUCTION | DISPERSING | STYRENE | 55 | ACRYLIC | 45 | — | — | 12000 | 1.67 |
| EXAMPLE 5 | RESIN 5 | | | ACID | | | | | |

*ATBS: 2-acrylamido-2-methylpropanesulfonic acid

### 2. Preparation of Varnish Solutions

To an 1 L eggplant-shaped flask equipped with a stirring bar and a Dimroth condenser, 15 parts by mass of the copolymer and 70 parts by mass of pure water were added, and the mixture was heated to 80° C. and thereafter stirred. Triethanolamine was added thereto until a pH of 7.6 was achieved, and thereafter pure water was further added thereto such that the total would be 100 parts by mass. Subsequently, the mixture was cooled to 25° C. to obtain a varnish solution containing 15% by mass of the copolymer.

### 3. Preparation of Dispersions

A total of 50 parts by mass of the varnish solution, 15 parts by mass of Disperse Yellow 232, and 35 parts by mass of pure water were added, and the mixture was pulverized with a bead mill for 1 hour to obtain a dispersion containing 6% by mass of the copolymer and 12% by mass of the color material.

### 4. Preparation of Ink Compositions

The dispersion and other components were mixed such that the compositions presented in Table 2 below would be achieved to obtain each ink composition. The composition of ink water used in the description of redispersibility below is also presented in Table 2.

### 5. Evaluation

### 5.1. Redispersibility

The ink composition prepared as described above was added dropwise to a microscope slide, and dried to be solidified. The microscope slide was thereafter immersed in a sample bottle containing the ink water, and the redispersion behavior of the solid was visually confirmed. The operation was performed with care taken to avoid the ink water being, for example, stirred. The term “ink water” refers to, in Table 2 above, a material containing neither color material nor dispersing resin. The evaluation criteria for redispersibility are presented below.

### Evaluation Criteria

A: The solid disappeared and redispersed.
B: A portion of the solid remained, but its redispersion was confirmed.
C: The solid remained, and no redispersion was confirmed.

### 5.2. Particle Size Distribution Change

The ink composition prepared as described above was placed into a sample bottle and left to stand at 60° C. for 5 days. The volume-based 50% cumulative particle diameter (D50) of the ink composition before and after being left to stand was measured in accordance with a dynamic light scattering method, and the change in the 50% cumulative particle diameter before and after being left to stand was confirmed. As the measurement apparatus, Microtrac UPA150 (product name, manufactured by Microtrac Inc.) was used. The particle size distribution change was calculated based on the obtained measurement results.

### Evaluation Criteria

A: The increase in the 50% cumulative particle diameter was less than 10%.
B: The increase in the 50% cumulative particle diameter was 10% or more and less than 30%.
C: The increase in the 50% cumulative particle diameter was 30% or more.

### 5.3. Viscosity Change

The ink composition prepared as described above was placed into a sample bottle and left to stand at 60° C. for 5 days. The viscosity at a shear rate of 10 (1/s) at 20° C. after being left to stand was measured with a digital viscometer VM-100 manufactured by Yamaichi Electronics Co., Ltd. The measurement criteria are presented below.

### Evaluation Criteria

A: The viscosity after being left to stand was 4 mPa·s or more and less than 6 mPa·s.
B: The viscosity after being left to stand was 6 mPa·s or more and less than 10 mPa·s.
C: The viscosity after being left to stand was 10 mPa·s or more.

TABLE 2

| | | | | | | COMPARA- | |
|---|---|---|---|---|---|---|---|
| | | EXAMPLES | | | | TIVE | INK |
| | | 1 | 2 | 3 | 4 | EXAMPLE | WATER |
| COLOR MATERIAL | | 3.0 | 3.0 | 3.0 | 3.0 | 3.0 | |
| DISPERSING RESIN 1 | | 1.5 | | | | | |
| DISPERSING RESIN 2 | | | 1.5 | | | | |
| DISPERSING RESIN 3 | | | | 1.5 | | | |
| DISPERSING RESIN 4 | | | | | 1.5 | | |
| DISPERSING RESIN 5 | | | | | | 1.5 | |
| ORGANIC | DIETHYLENE | 10.0 | 10.0 | 10.0 | 10.0 | 10.0 | 10.0 |
| SOLVENT | GLYCOL | | | | | | |
| | 1,2-HEXANEDIOL | 3.0 | 3.0 | 3.0 | 3.0 | 3.0 | 3.0 |
| OTHER | CARBOXYMETHYL | | | | | | |
| RESINS | CELLULOSE | 1.0 | 1.0 | 1.0 | 1.0 | 1.0 | 1.0 |
| | SODIUM | | | | | | |
| | SALT | | | | | | |
| SURFACTANT | BYK-348 | 0.3 | 0.3 | 0.3 | 0.3 | 0.3 | 0.3 |
| pH ADJUSTER | TRIETHANOLAMINE | 1.0 | 1.0 | 1.0 | 1.0 | 1.0 | 1.0 |
| WATER | | BALANCE | BALANCE | BALANCE | BALANCE | BALANCE | BALANCE |
| TOTAL | | 100 | 100 | 100 | 100 | 100 | 100 |
| EVALUATION | REDISPERSIBILITY | A | A | A | A | C | — |
| | PARTICLE SIZE | A | B | A | B | C | — |
| | DISTRIBUTION | | | | | | |
| | CHANGE | | | | | | |
| | VISCOSITY | A | A | A | A | C | — |
| | CHANGE | | | | | | |

Carboxymethyl cellulose sodium salt: Manufactured by FUJIFILM Wako Pure Chemical Corporation
BYK-348: Silicone surfactant, manufactured by BYK-Chemie Gmbh

As described above, it is revealed that the ink compositions of Examples containing the dispersion according to the present disclosure have excellent redispersibility, exhibit only a small particle size distribution change and viscosity change even before and after heat storage, and have excellent ejection stability compared with an ink composition of Comparative Example.

What is claimed is:

1. A dispersion comprising:
water;
a color material; and
a dispersing resin that disperses the color material, the dispersing resin having
a structural unit A containing a hydrophobic monomer;
a structural unit B containing a hydrophilic acrylic acid monomer; and
a structural unit C containing a sulfonic acid group-containing acrylamide monomer, wherein
the dispersing resin has a weight average molecular weight of from 5000 to 100000 and
a content of the structural unit A is 60 mol % or more with respect to a total amount of the dispersing resin.

2. The dispersion according to claim 1, wherein
the dispersing resin has a weight average molecular weight of from 7000 to 60000.

3. The dispersion according to claim 1, wherein
the hydrophobic monomer includes an aromatic group-containing vinyl monomer and a hydrocarbon group-containing acrylic acid ester monomer.

4. The dispersion according to claim 1, wherein
the hydrophilic acrylic acid ester monomer includes a (meth)acrylic acid and a polyalkylene glycol group-containing acrylic acid ester monomer.

5. The dispersion according to claim 1, wherein
the acrylamide monomer includes 2-acrylamido-2-methylpropanesulfonic acid.

6. The dispersion according to claim 1, wherein
the content of the structural unit A is from 61 to 70 mol % with respect to the total amount of the dispersing resin.

7. The dispersion according to claim 1, wherein
a content of the structural unit B is from 7 to 16 mol % with respect to the total amount of the dispersing resin.

8. The dispersion according to claim 1, wherein
a content of the structural unit C is from 15 to 32 mol % with respect to the total amount of the dispersing resin.

9. The dispersion according to claim 1, wherein
a content of the color material is from 7.5 to 30% by mass with respect to a total amount of the dispersion.

10. The dispersion according to claim 1, wherein
a content of the dispersing resin is from 2.5 to 10% by mass with respect to a total amount of the dispersion.

11. An ink composition for ink jet recording, comprising:
the dispersion according to claim 1,
a surfactant, and
a water-soluble organic solvent.

12. A dispersing resin comprising:
a structural unit A containing a hydrophobic monomer;
a structural unit B containing a hydrophilic acrylic acid monomer; and
a structural unit C containing a sulfonic acid group-containing acrylamide monomer, wherein
the dispersing resin has a weight average molecular weight of from 5000 to 100000 and
a content of the structural unit A is 60 mol % or more with respect to a total amount of the dispersing resin.
